(19) United States
(12) Patent Application Publication
(10) Pub. No.: US 2009/0248433 A1
(43) Pub. Date: Oct. 1, 2009

(54) METHOD FOR AUTOMATICALLY LINKING A DATA ELEMENT TO EXISTING RESEARCH

(76) Inventors: J. Michael Earley, JR., Amherst, NH (US); Daniel J. Dykens, JR., Norwell, MA (US); David F. Earley, Duxbury, MA (US)

Correspondence Address: GAUTHIER & CONNORS, LLP, 225 FRANKLIN STREET, SUITE 2300, BOSTON, MA, 02110, US

(21) Appl. No.: 12/060,560

(22) Filed: Apr. 1, 2008

(51) Int. Cl. G06Q 99/00

(52) U.S. Cl. 705/1

(57) ABSTRACT

Business research items are maintained for a subscriber, wherein the business items are any of the following: company information, contact information, ideas, themes, or notes. When the user creates a new item for business research, the input is parsed to match the parsed user input to indexed research to identify a matching entry (or entries), wherein a link is automatically suggested between the matching entry (or entries) and the new item to be created. Upon receiving an acknowledgement from the user accepting the suggestion, the suggested link is stored in permanent memory.

### RELATED APPLICATIONS

This application is related to the application entitled, “HEURISTIC MATCHING METHOD FOR USE IN FINANCIAL SYSTEMS,” which is incorporated by reference in its entirety.

### BACKGROUND OF THE INVENTION

1. Field of Invention

The present invention relates generally to the field of financial systems. More specifically, the present invention is related to a system and method for automatic linking a data element to existing research.

2. Discussion of Prior Art

The vast majority of institutional research professionals are conducting research in one of two ways. Many research professionals are taking notes using a word processing application such as Microsoft Word™. They then save those notes to a shared server within their office which their colleagues also have access to. These shared servers typically have hundreds or thousands of folders set up with ticker symbols or company names. The research professional will save their notes in the folder of the company that they are focusing their research attention on. This method of saving research makes this research available to other research and investment professionals within the investment firm but there is no alerting mechanism to alert colleagues of this new information. The second widely adopted method of saving research is done within email applications such as Microsoft Outlook™. The research professional operating under this method will type up their notes within the email application and email the research to their colleagues. After the research is sent, the sender typically will save a copy in their outbox or they will create a folder within their email application with a ticker symbol or company name on each folder. This method provides for alerting but many emails go unnoticed due to the high volume of emails received on the client's side. The folders are also not accessible by other colleagues within the firm. Often times, a research note pertains to multiple companies, people, industries and investment themes. These notes that pertain to to numerous companies, people, industries and investment themes are not typically copied and saved in all of the corresponding folders of the companies, people, industries and investment themes that are mentioned within the note. As an example a research professional conducting due diligence on a specific company, such as Apple Computer will likely take a note that references Apple's executives and the executives of their key suppliers and competitors. This note may also reference the Wall Street analysts that conduct research on Apple. This note most likely mentions the companies that Apple competes with as well as their key suppliers. Under the current workflow adopted by the vast majority of research professionals, this note will often be saved within the AAPL folder. As a result, none of the pertinent information relating to the other companies, people, industries and investment themes referenced within this note can be found in more intuitive locations and valuable information is often never made available to other research and investment professionals within the firm.

There are two other commercial research systems on the market. The systems are offered by Tamale Software® and Code Red Inc®. Both of these systems require that their own servers be installed on the clients' premises and these applications do not automatically suggest links to relevant items such as people, companies, industries and investment themes. Tamale research only allows their users to link items to companies and this process is done manually. For example, if a research professional wanted to link a person to another person they would have to link each of them to the same ticker symbol (company) even if these people do not both work at that company. These relationships often do not make much sense and they are very cumbersome to establish. Code Red's product also requires their clients to manually link items together which is time consuming.

What is absent in the prior art research systems is a robust method for automatically linking a data element to existing research. Whatever the precise merits, features, and advantages of the above mentioned prior art research systems, none of them achieves or fulfills the purposes of the present invention.

### SUMMARY OF THE INVENTION

The present invention provides for a method comprising the steps of: (a) maintaining business research items for a subscriber, wherein the business items comprise combinations of the following: company information, contact information, ideas, themes, or notes; (b) receiving a user input for creating a new item for business research, wherein the business research is chosen from any of the following: company information, contact information, ideas, themes, or notes; (c) parsing the received user input and matching parsed user input to indexed research to identify at least one matching entry; (d) automatically suggesting a link between the matching entry and the created new item; and (e) upon receiving an acknowledgement accepting the suggested link, permanently storing the suggested link between the matching entry and the newly created item.

The present invention also provides for a method comprising the steps of: (a) maintaining business research items for a subscriber, wherein the business items comprise combinations of the following: company information, contact information, ideas, themes, or notes; and (b) receiving instructions for creating a new item for business research, wherein the business research is chosen from any of the following: company information, contact information, ideas, themes, or notes; (c) parsing the received user input and matching parsed user input to indexed research to identify at least one matching entry; (d) automatically suggesting a link between the matching entry and the newly created item; (e) upon receiving an acknowledgement accepting the suggested link, permanently storing the suggested link between the matching entry and the newly created item; (f) receiving an input identifying filtering criteria associated with the newly created item for business research; and (g) based on the filtering criteria, assigning any of the following access rights: make public read only, make public read/write, and make private, wherein the filtering criteria permits said subscriber to define who within an organization has access to the newly created item for business research.

The present invention also provides for an article of manufacture comprising computer usable medium having computer readable program code embodied therein which implements the above-described methods.

### BRIEF DESCRIPTION OF THE DRAWINGS

FIGS. 1a-b illustrate a sample login screen associated with the present invention's financial system.

FIGS. 2a-c illustrate the main window rendered to a user of the present invention's financial system.

FIGS. 3 and 4a-c illustrate the creation of a new Watchlist or a new Research List.

FIG. 5 illustrates options to include various visibility and access rights to user created Watchlists and Research Lists.

FIG. 6 illustrates the interface that is rendered upon picking the “Add Company” option.

FIG. 7 illustrates an example depicting the insertion of an RSS feed.

FIG. 8 illustrates the interface wherein the user is able to enter a URL corresponding to a RSS feed of interest.

FIG. 9 illustrates the “Outlook Auto Indexer” feature of the present invention.

FIG. 10 illustrates the section in the navigation pane (the left most pane) where the user can select to add new companies, contacts, themes, ideas and notes.

FIGS. 11a-b illustrate the interface the user interacts with to add a company or to add a contact.

FIG. 12a illustrates the interface for adding a new note.

FIG. 12b illustrates an interface that is presented to the user to select objects to link to the current note that is being created.

FIG. 12c illustrates an example showing automatic suggested links.

FIG. 13a illustrates a sample research view associated with a company.

FIG. 13b illustrates the interface rendered when the “Related Notes” option is selected.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

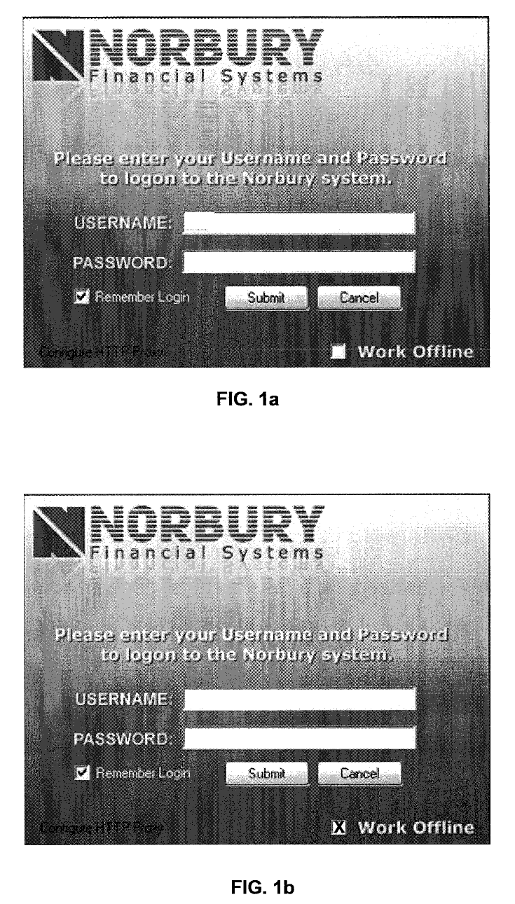

FIGS. 1a-b illustrate a sample login screen associated with the present invention's financial system. To access the financial system, the user clicks on an icon located on their desktop, and is prompted to enter their username and password (which may be provided in an email at the time of enrollment) as shown in FIG. 1a. The user can optionally check the “Remember Login” box in order to store their password for subsequent logins.

FIG. 1b illustrates a specific scenario wherein the user does not have to be online to use the present invention's financial system. To work offline, the user checks the “Work Offline” button located in the bottom corner of the login window. A synchronization process is affected when connectivity is established to synchronize the contents of user's computer with that of a server housing the user's data.

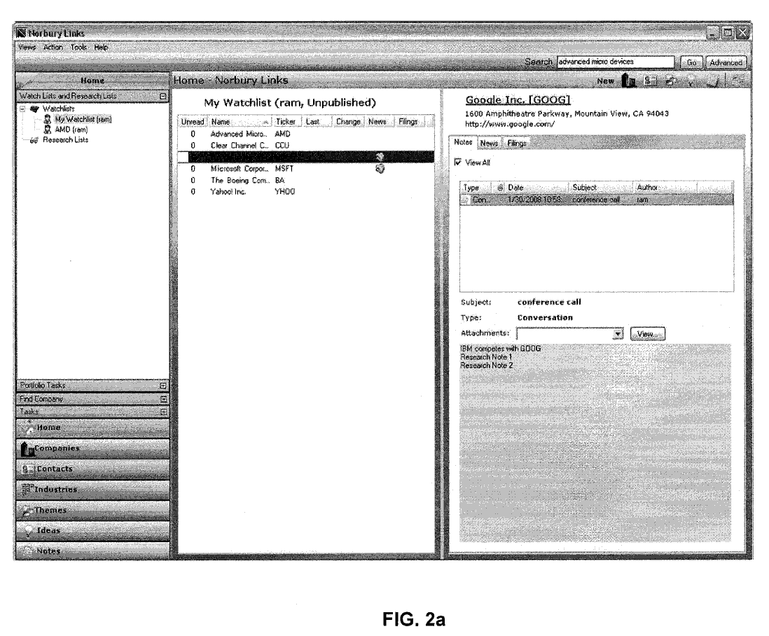

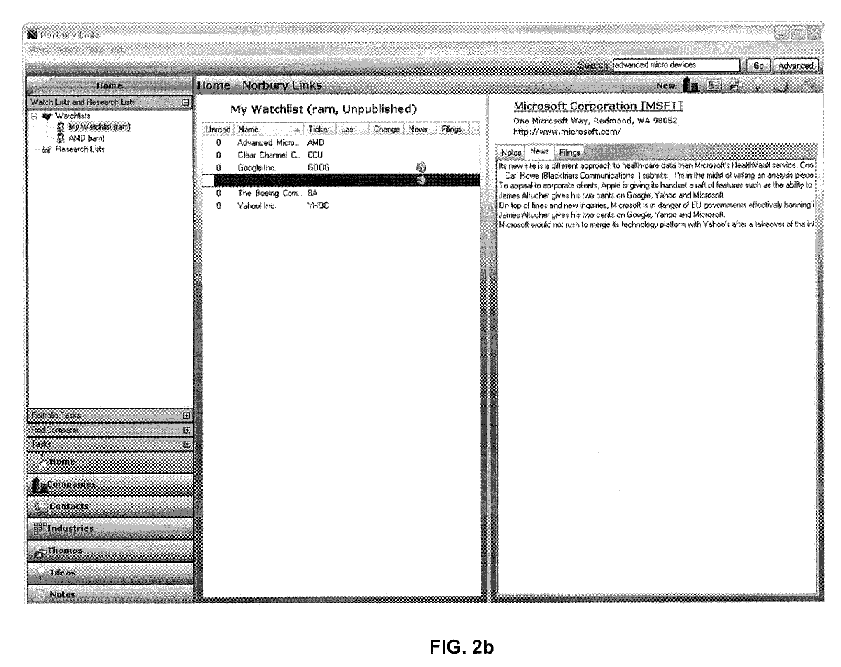

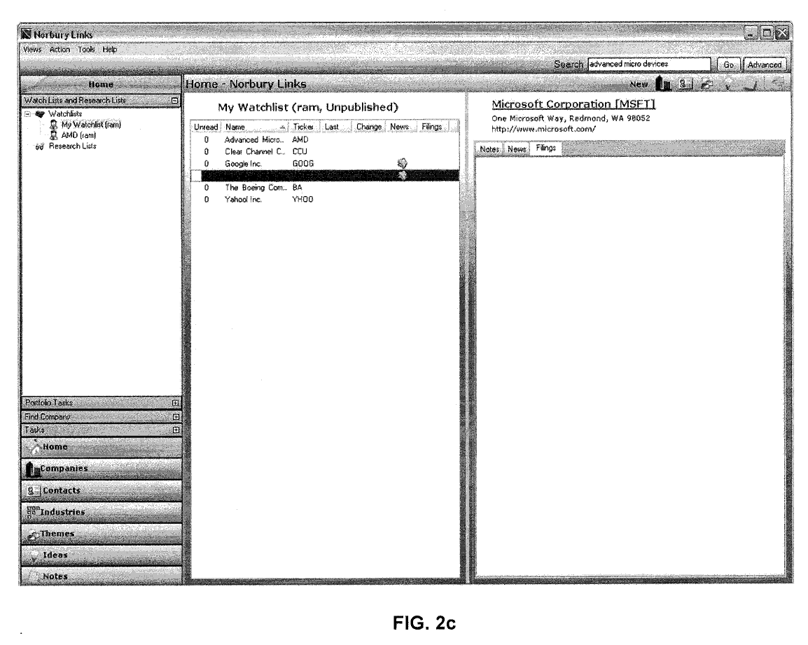

Upon logging in, the user is displayed a screen such as the one shown in FIG. 2a. The main window is divided into three panes or regions. The left most pane depicts various headings that a user can select. In this example, such headings include (but should not be limited to): home, companies, contacts, industries, themes, ideas, and notes. Home is the main section within the application where a user can customize their view of research data specific to their needs. All other major section (i.e., companies, contacts, industries, themes, and ideas) contain all data viewable by a particular user should they wish to search across all the data within a given category.

Under the ‘Home’ heading, the user is able to maintain and view various watch lists and research lists. In the example shown in FIG. 2a, the watchlist titled ‘My Watchlist’ is selected and details associated with this watchlist are displayed. In the displayed example, the watchlist ‘My Watchlist’ has six companies listed in it—Advanced Micro Devices®, Clear Channel®, Google®, Microsoft®, Boeing®, and Yahoo®. In this example, Google is selected by the user in the middle pane and, in response to this selection, information about Google is displayed in the right most pane titled “Google Inc. [GOOG]’. The default for displaying information in the right most pane is set to the ‘Notes’ option which includes all notes related to the selected company (i.e., Google), however, the user can select the ‘News’ option to display News related to the selected company, as shown in FIG. 2b (the selected company in this case being Microsoft), or the user can select the ‘Filings’ option to display public filings associated with the selected company, as shown in FIG. 2c (the selected company in this case being Microsoft).

Although the present invention specifically teaches the separate maintenance of Watchlists and Research Lists, it should be emphasized that the two lists can be merged into one list that accommodates people, companies, themes, and ideas with RSS feed capability. Alternatively, the maintenance of more than two types of lists are also considered within the scope of the present invention.

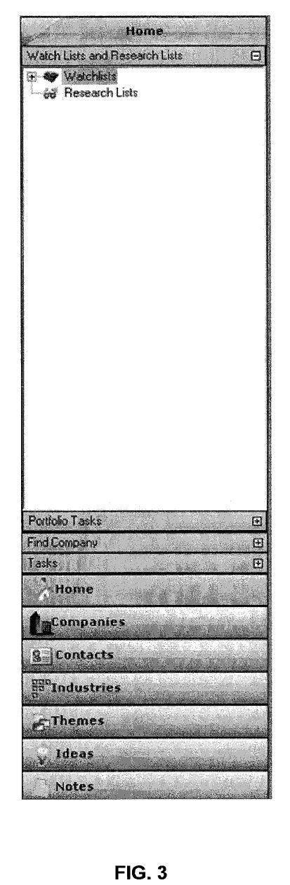

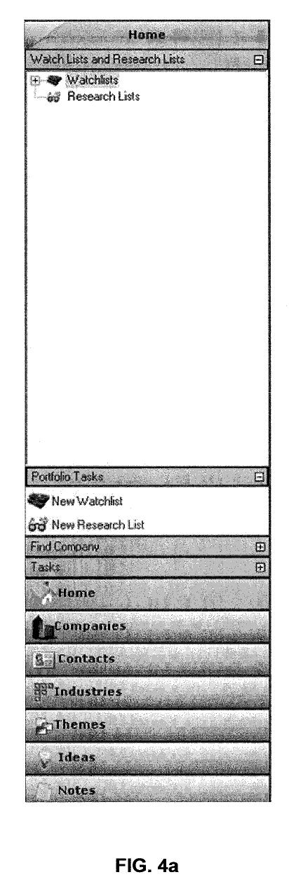

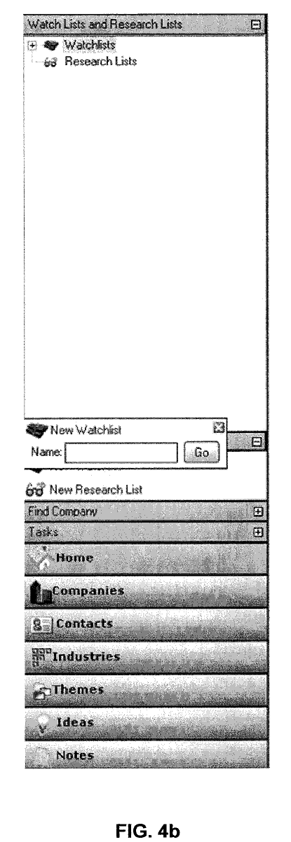

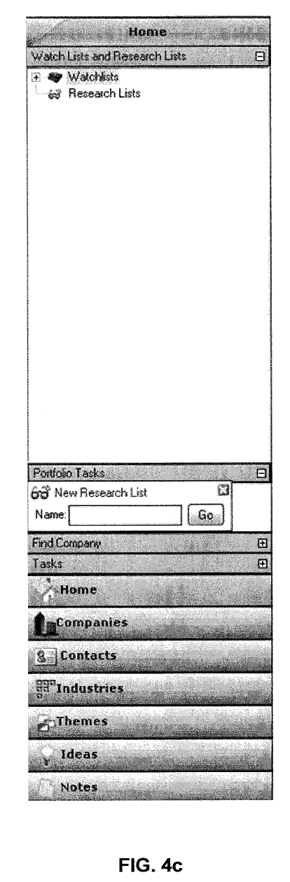

FIGS. 3 and 4a-c illustrate the creation of a new Watchlist or a new Research List. FIG. 3 illustrates the “Portfolio Tasks” option that the user selects the left most pane to expand and reveal two options. FIG. 4a illustrates the expanded options which include an option to create a new Watchlist—option titled “New Watchlist”—and an option for creating a new Research List—Option titled “New Research List”. FIG. 4b illustrates the window generated upon selecting the “New Watchlist” option in FIG. 4a. In FIG. 4b, the user is able to enter the name of the new Watchlist and create the same by clicking the “Go” button. In FIG. 4c, the user is able to enter the name of the new Research List and create the same by clicking the “Go” button.

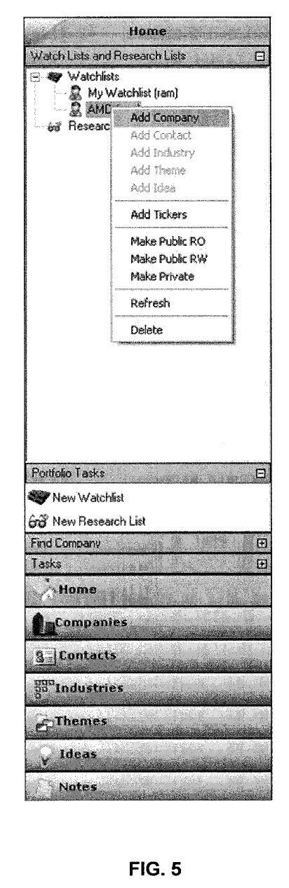

FIG. 5 illustrates options to include various visibility and access rights to user created Watchlists and Research Lists. For example, a newly created Watchlist or Research List can be set to any of the following access rights: public read-only (offering the public read access and no write access), public read-write (offering the public read and write access), or private (offering the public no read or write access). It should be noted that the use of the term public refers to other subscribers of the present invention's financial services with whom the user can share collected information. For assigning such rights, the user first clicks on the name of the new Watchlist or Research List that they wish to assign such rights and then select one of the above-mentioned options (i.e., public read-only, public read-write, or private).

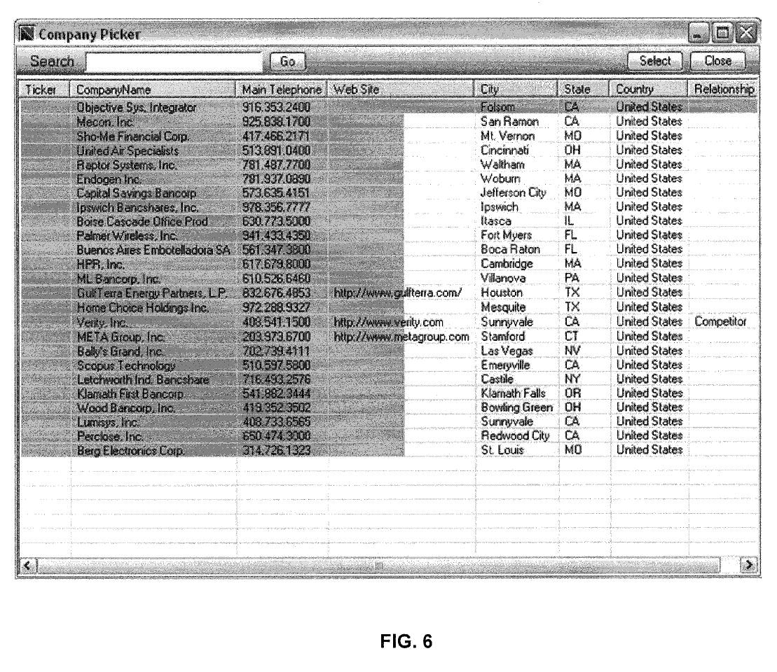

In the menu shown in FIG. 5, the user can also choose to add a company to a current watchlist by picking the “Add Company” option. Upon picking the “Add Company” option, the user is presented with the window shown in FIG. 6. In the interface shown in FIG. 6, the user can either pick a company from the list of displayed companies or, alternatively, the user can type the name of the company in the search dialog and pick a match or matches that are relevant to him/her.

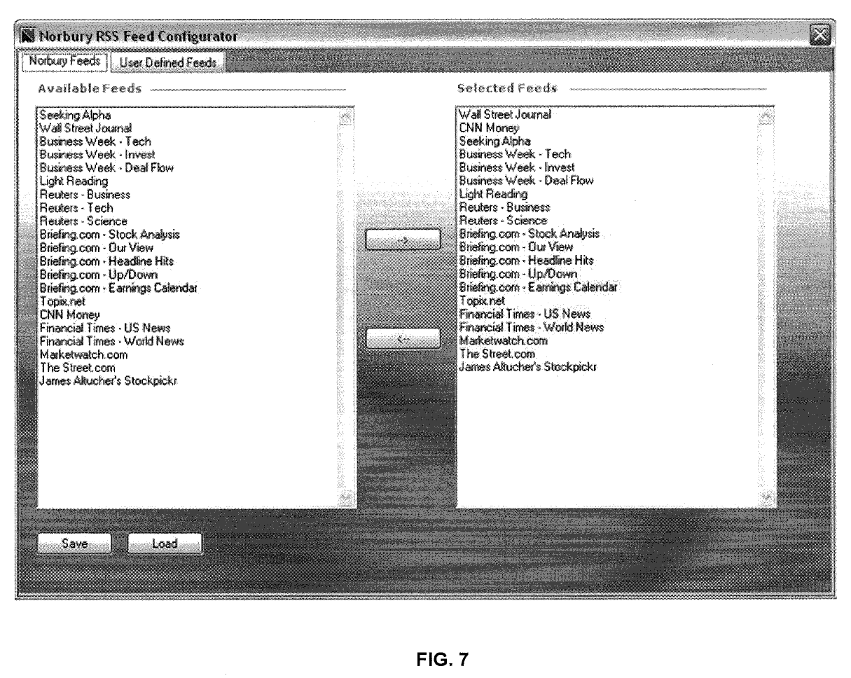

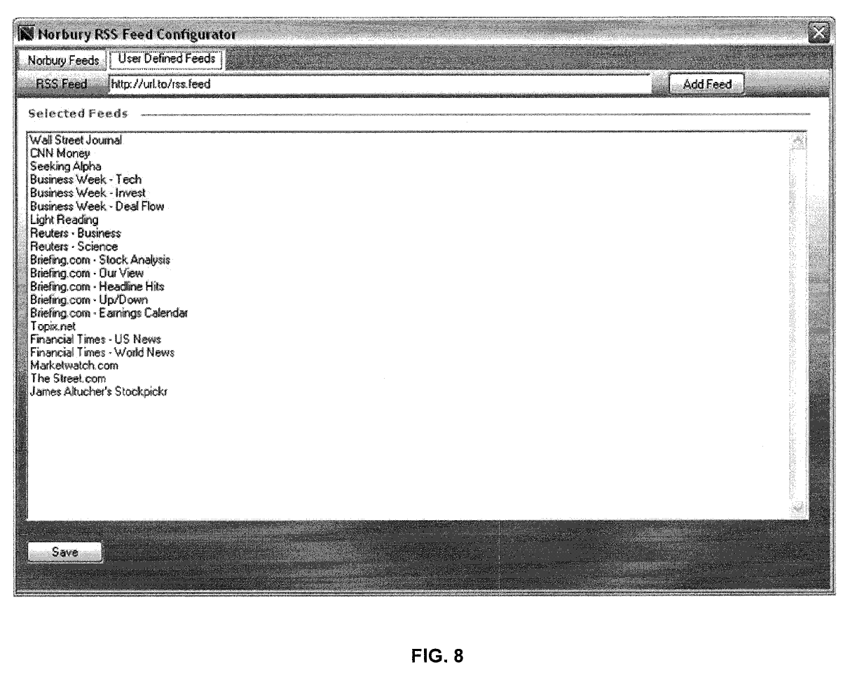

FIG. 7 illustrates an example depicting the insertion of an RSS feed. To set up an RSS Feed, the user clicks on Tools in the main menu and selects the “RSS Configuration” option. Here the user is presented with two options. The first option involves the user picking RSS feeds from a list of pre-defined RSS feeds (titled “Norbury Feeds” in FIG. 7) and the second option involves the user specifying one or more RSS feed(s) via the option titled “User Defined Feeds” shown in FIG. 7. FIG. 7 illustrates an example of pre-defined RSS feeds that the user can pick from. FIG. 8 illustrates the interface wherein the user is able to enter a URL corresponding to a RSS feed of interest.

If there is a press release for one of the companies in the Watchlist, the user sees a newspaper icon next to the company name. Clicking on the company name populates summary text from the press release within the News tab. To view the full press release, users highlight and double click on the relevant portion of the news summary. A PR Newswire press release will open in the user's web browser.

Although, press releases are mentioned as part of the RSS feature of the present invention, it should be noted that the RSS feature associated with the present invention includes any data delivered via RSS. For example, data related to a website that specifically mentions the name of a company or data related to a particular blog that specifically mentions the name of a company can be delivered via RSS.

If there is a new filing for one of the companies in the Watchlist, the user will see an icon in the Filings column next to the company name within the Watchlist. Clicking on the company name populates the Filings tab with a list of SEC Filings. Users are able to double click on the filing name to view the full text associated with the particular filing.

The global search feature allows the user to search for files across the external server, local hard drives, as well as any shared drives within an organization. The user can also conduct a full text search across all attachments including notes, Word documents, Excel spreadsheets and PDF files. The search can also be limited to local resources (i.e., local hard drives or local drives shared within an organization).

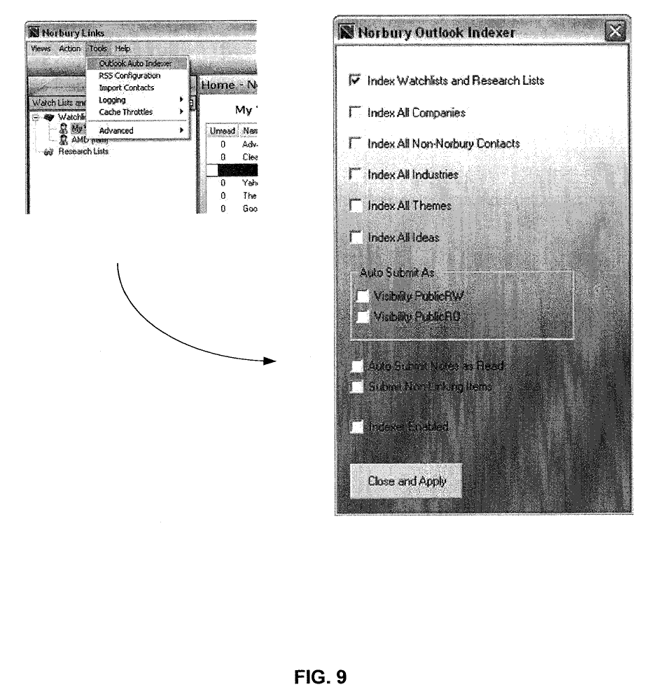

FIG. 9 illustrates the “Outlook Auto Indexer” feature of the present invention, wherein, when enabled, mail messages in a mail program such as Outlook™, are automatically indexed. The process of indexing emails is a crucial time savings function for users as many research analysts receive over 500 emails per day. Much of the information within these emails is valuable, but this data is typically lost among all of the unwanted emails received. The present invention's indexer culls this data based on user preferences, allowing the user to programmatically strip out data that is valuable to them without spending the hours each day it would take to do this manually. User preferences are described below.

Index Watch Lists and Research Lists: this option allows users to limit the data that is pulled in from email programs based on user preferences defined on their customized home page. For instance, if a user only placed one company, one industry, and one theme on their Home page and then set up their indexer to only index based on Watch List and Research List items, their emails would be filtered based only on these three criteria. This particular set up would most likely have the effect of drastically reducing the amount of emails presented to the user based on only these critical items that the user specified.

The next five items: 1) Index all Companies, 2) Index all non-Norbury contacts, 3) Index all Industries, 4) Index all Themes, and 5) Index all Ideas allows the user to broaden the scope of what is searched for programmatically based on specific system objects. For instance, some users may want the present invention's indexer to search for all items on their Home page but additionally search for data related to all Themes that have been set up. This setup would programmatically pull in relevant data to specific Themes identified as important to a user, and automatically link this email data to these specific Themes.

In addition to options related to what data is programmatically searched for, the user also has several options available related to how the data is pulled into the present invention's software and organized for them. The system default pulls all data in as Private, so that the information is only visible to that specific user. A user could modify this default by selecting either Auto Submit as Public RO or Public RW. RO stands for Read Only and RW stands for Read Write. These options allow users to collaborate with other authorized users by sharing research data with them. For instance, if a user customizes their set up to submit indexed data as Public RW, then every other user within that organization would have immediate access to see the data that was entered, as well as to add or modify the data that has been entered.

In addition to being able to filter specific data for inclusion, and in addition to customizing specific items related to how the data is entered programmatically, the user can elect to submit all email data. By doing this users are ensuring that their email data is backed up into their research database, and they are also able to conduct future searches on this data directly from within the present invention's software.

Further, specific rules can be set up in the mail program to route incoming mail that matches certain criteria (e.g., mail from A or B containing the terms “financial” or “earnings” in the subject of the email) to a previously assigned folder. Users then can chose to automatically index only for messages in this assigned folder.

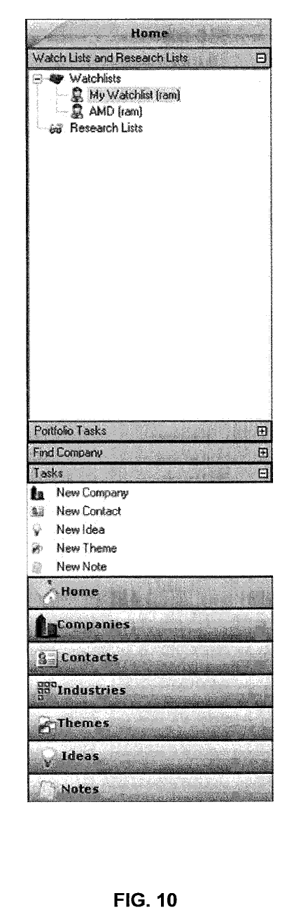

FIG. 10 illustrates the section in the navigation pane (the left most pane) where the user can select to add new companies, contacts, themes, ideas and notes. Themes provide a fully customizable keyword match that is specific to each user. For example a Theme could be entered as “Rising Oil Rates” or “Outsourcing to China”—in this way a user has entered very specific key words by which research data can be organized. As users interact with the system, data that is being entered will be automatically linked to these customized Themes if textual matches are found thereby automating the organization of research for users. Ideas work in the same way as Themes, that is, Ideas are completely customized by each user and the automatic Linking of data and organization of data is driven based on user defined entry.

When research data is entered into the software, it is entered as a Note. Notes are user defined, flexible, and can be linked to any object within a database. For instance, a user could enter a Note and then link this information to several Companies, several Contacts, several Industries, several Themes, and several Ideas. The user could also elect to keep the note Private, visible only to that specific user, or they could share the note by allowing other users to see the Note but make no modifications to it (Public RO), or they could grant other users the flexibility to add or modify the content of the Note (Public RW).

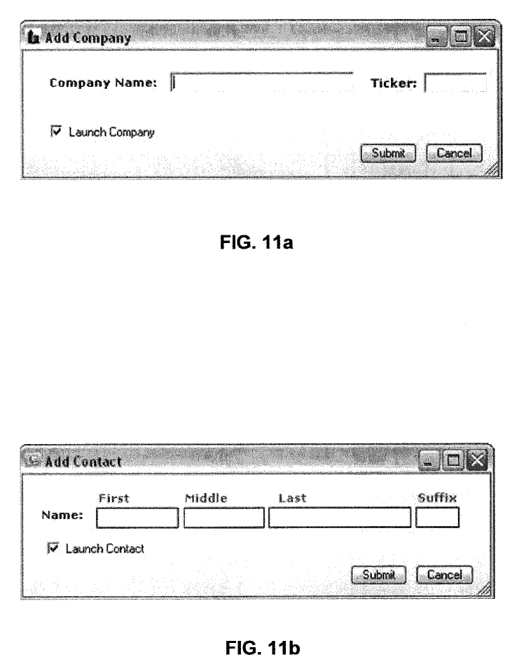

FIGS. 11a-b illustrate the interface the user interacts with to add a company or to add a contact.

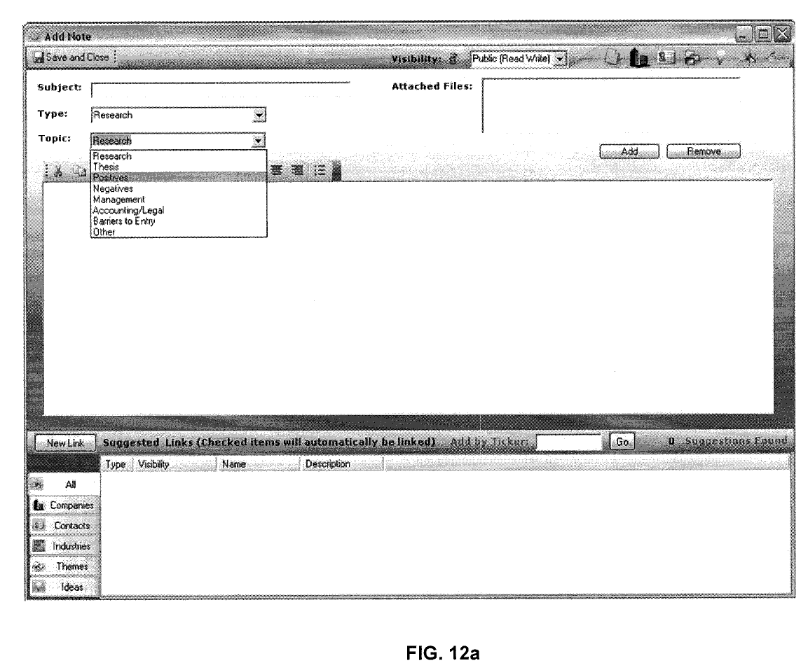

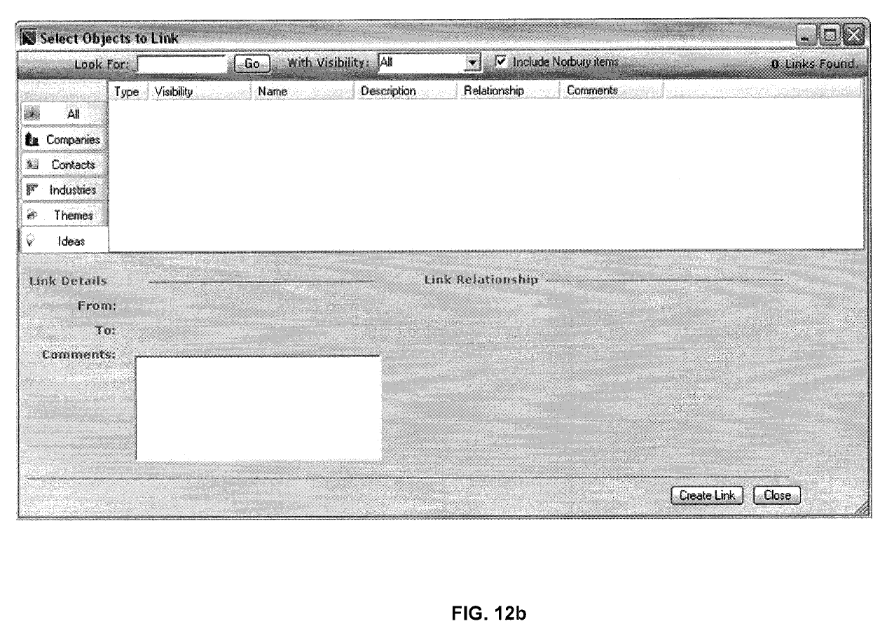

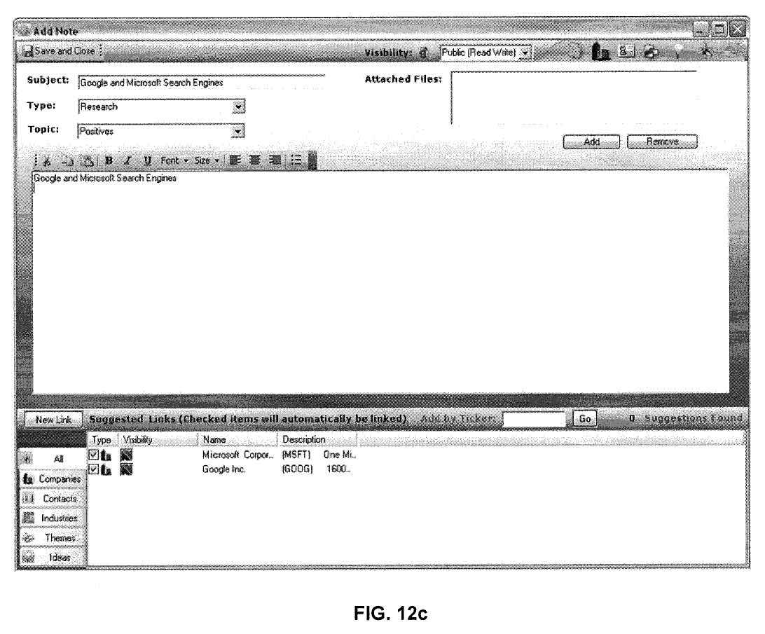

FIG. 12a illustrates the interface for adding a new note. When a new note is created, the user is able to specify a subject of the note (via the field titled “Subject:”). The user is also able to classify the type of note by picking, from a pull down menu, a type to be associated with the new note to be created. Additionally, the users are also able to specify a topic to associate the new note to be created by picking from a pull down menu. Further, the user can also choose to attach one or more files to the note to be created by choosing the “Add” option shown in FIG. 12a. If an attached file needs to be removed, the user can select the file in the “Attached Files” box and click on the “Remove” button.

In the interface shown in FIG. 12a, the user is able to link the note to be created to a specific company, contact, industry, theme, or idea by clicking on the button titled “New Link”. FIG. 12b illustrates an interface that is presented to the user to select objects to link to the current note that is being created. The term ‘link’ is used within the present invention's software as a way to tag specific data elements to other data elements. The present invention provides an extremely flexible design that allows users to Link data in ways that helps them organize information that they deem important in ways that they deem logical. For example, a user might decide to Link one contact to another contact because there is some specific relationship that exists between these contacts that is relevant to the user of the present invention's software. The user might decide to link two contacts together because they are co-workers, because they are in a related industry, because they are both alumni of the same school, or for any other multitude of reasons which are important to the user. In order to provide as much flexibility as possible, the present invention's software allows users to specify the details of these relationships in their own words via a link comment. A link comment can be added to any link a user makes to further clarify why the user made the link, and to help aid others viewing the link to understand any relationship that exist.

The present invention is also able to automatically suggest links based on the content of the note. FIG. 12c illustrates such an example. In this example, the user starts by adding a new note. When the user types the phrase “Google and Microsoft Search Engines” in the “Subject” field, the present invention's method automatically identifies company names, i.e., Google™ and Microsoft™, in the typed phrase and the present invention's method automatically links existing research for each of these companies. The “Suggested Links” pane in the interface shown in FIG. 12c is automatically populated with the suggested links generated based on parsing the subject line and the content of the note.

Alternatively, the user can also manually create a link from a newly created note to a specific company, contact, industry, theme or idea. To aid users with the organization of their data, the present invention's software automatically searches through a user's data set to try to determine logical links to make for them. For instance if a user is taking a note based on a phone call with an industry expert and they discuss ‘Solar Power Elements’, and the user has ‘Solar Power Elements’ established as a theme within their instance of the present invention's software, then the theme ‘Solar Power Elements’ will automatically suggest as a link for the user. In this way the user does not have to manually go back and establish the relationship between the note being taken and the theme established within the present invention's software. This process of suggesting links automatically is a highly used feature within the application. Links are suggested based on all objects within the present invention's software (i.e., companies, contacts, industries, themes, ideas).

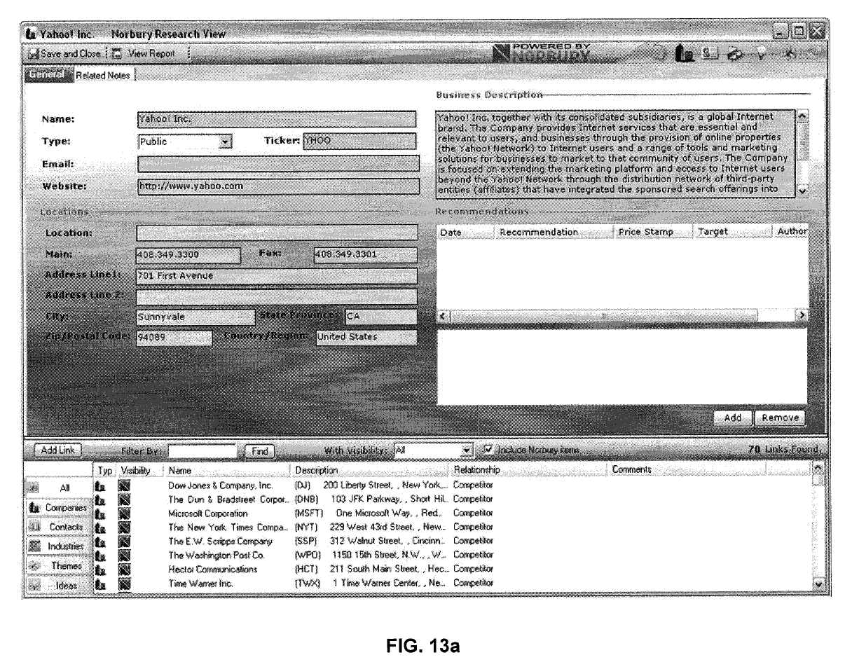

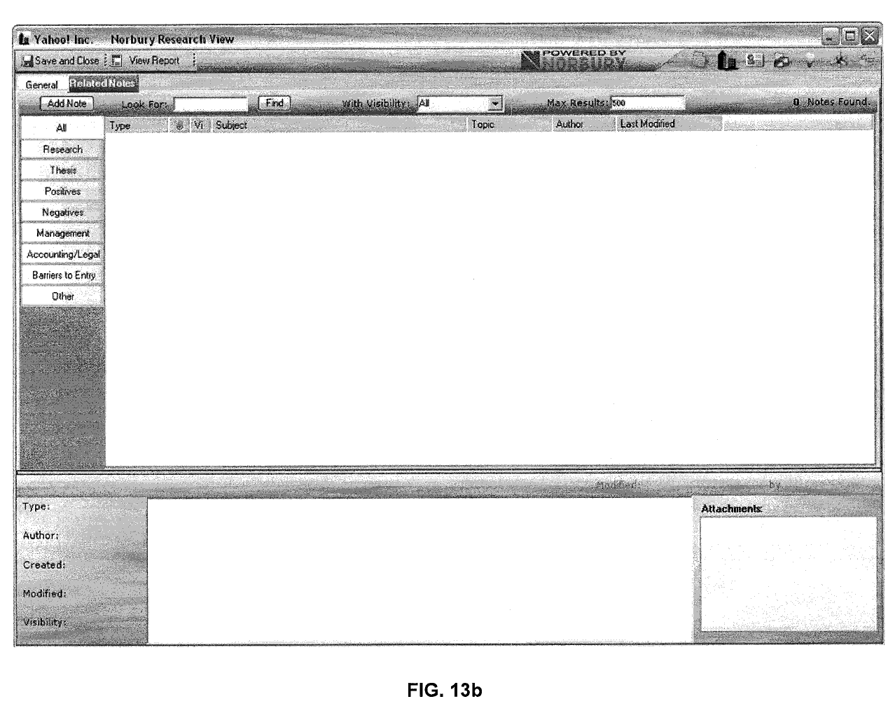

FIG. 13a illustrates a sample research view associated with a company (e.g., Yahoo! Inc.). This view provides various details associated with the company (including type, ticker symbol, website, email, address, phone number, etc.), business description of the company, recommendations associated with the company, and the links associated with the company. FIG. 13b illustrates the interface rendered when the “Related Notes” option is selected.

Additionally, the present invention provides for an article of manufacture comprising computer readable program code contained within implementing one or more modules to automatically link a data element to existing research. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Another aspect of the present invention provides for an article of manufacture comprising computer readable program code having computer usable code, wherein the medium comprises: (a) computer readable program code maintaining business research items for a subscriber, wherein the business items comprise combinations of the following: company information, contact information, ideas, themes, or notes; (b) computer readable program code working with a computer to receive a user input for creating a new item for business research, wherein the business research is chosen from any of the following: company information, contact information, ideas, themes, or notes; (c) computer readable program code parsing the received user input and matching parsed user input to indexed research to identify at least one matching entry; (d) computer readable program code automatically suggesting a link between the matching entry and the created new item; and (e) computer readable program code, upon receiving an acknowledgement accepting the suggested link, working with a computer to permanently store the suggested link between the matching entry and the newly created item.

Yet another aspect of the present invention provides for an article of manufacture comprising computer readable program code having computer usable code, wherein the medium comprises: (a) computer readable program code maintaining business research items for a subscriber, wherein the business items comprise combinations of the following: company information, contact information, ideas, themes, or notes; and (b) computer readable program code receiving instructions for creating a new item for business research, wherein the business research is chosen from any of the following: company information, contact information, ideas, themes, or notes; (c) computer readable program code parsing the received user input and matching parsed user input to indexed research to identify at least one matching entry; (d) computer readable program code automatically suggesting a link between the matching entry and the newly created item; (e) upon receiving an acknowledgement accepting the suggested link, permanently storing the suggested link between the matching entry and the newly created item; (f) computer readable program code working with a computer to receive an input identifying filtering criteria associated with the newly created item for business research; and (g) computer readable program code, based on the filtering criteria, assigning any of the following access rights: make public read only, make public read/write, and make private, wherein the filtering criteria permits said subscriber to define who within an organization has access to the newly created item for business research.

### CONCLUSION

A system and method has been shown in the above embodiments for the effective implementation of a system and method for automatic linking a data element to existing research. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats.

1. A method comprising the steps of:
a. maintaining business research items for a subscriber, said business research items comprising combinations of the following: company information, contact information, ideas, themes, or notes; and
b. receiving a user input for creating a new item for business research, said new item for business research chosen from any of the following: company information, contact information, ideas, themes, or notes;
c. parsing said received user input and matching parsed user input to indexed research to identify at least one matching entry;
d. automatically suggesting a link between said at least one matching entry and said created new item; and
e. upon receiving an acknowledgement accepting said suggested link, permanently storing said suggested link between said at least one matching entry and said created new item.

2. The method of claim 1, wherein at least one business research item belongs to another subscriber.

3. The method of claim 1, wherein research items are associated with any of the following access rights: make public read only, make public read/write, and make private.

4. The method of claim 1, wherein at least one business research item has an associated RSS feed providing additional information.

5. The method of claim 1, wherein at least one business research item provides public filing information associated with a company.

6. The method of claim 1, wherein method is implemented across one or more networks.

7. The method of claim 2, wherein networks are any of, or a combination of, the following: local area network (LAN), wide area network (WAN), or the Internet.

8. An article of manufacture storing computer readable program code implementing a method to automatically link a data element to existing research, said medium comprising:
f. computer readable program code maintaining business research items for a subscriber, said business items comprising combinations of the following: company information, contact information, ideas, themes, or notes; and
g. computer readable program code receiving a user input for creating a new item for business research, said business research chosen from any of the following: company information, contact information, ideas, themes, or notes;
h. computer readable program code parsing said received user input and matching parsed user input to indexed research to identify at least one matching entry;
i. computer readable program code automatically suggesting a link between said at least one matching entry and said created new item; and
j. computer readable program code, upon receiving an acknowledgement accepting said suggested link, permanently storing said suggested link between said at least one matching entry and said created new item.

9. The article of manufacture of claim 8, wherein at least one business research item belongs to another subscriber.

10. The article of manufacture of claim 8, wherein at least one business research item has an associated RSS feed providing additional information.

11. The article of manufacture of claim 8, wherein at least one business research item provides public filing information associated with a company.

12. The article of manufacture of claim 8, wherein research items are associated with any of the following access rights: make public read only, make public read/write, and make private.

13. A method comprising the steps of:
a. maintaining business research items for a subscriber, said business items comprising combinations of the following: company information, contact information, ideas, themes, or notes; and
b. receiving instructions for creating a new item for business research, said business research chosen from any of the following: company information, contact information, ideas, themes, or notes;
c. parsing said received user input and matching parsed user input to indexed research to identify at least one matching entry;
d. automatically suggesting a link between said at least one matching entry and said created new item;
e. upon receiving an acknowledgement accepting said suggested link, permanently storing said suggested link between said at least one matching entry and said created new item;
f. receiving an input identifying filtering criteria associated with said newly created item for business research; and
g. based on said filtering criteria, assigning any of the following access rights: make public read only, make public read/write, and make private, wherein said filtering criteria permits said subscriber to define who within an organization has access to the newly created item for business research.

14. The method of claim 13, wherein at least one business research item belongs to another subscriber.

15. The method of claim 13, wherein at least one business research item has an associated RSS feed providing additional information.

16. The method of claim 13, wherein at least one business research item provides public filing information associated with a company.

17. The method of claim 13, wherein method is implemented across one or more networks.

18. The method of claim 17, wherein networks are any of, or a combination of, the following: local area network (LAN), wide area network (WAN), or the Internet.
